(19) United States
(12) Patent Application Publication
(10) Pub. No.: US 2018/0246691 A1
(43) Pub. Date: Aug. 30, 2018

(54) SERVER, PROGRAM, AND TRANSMISSION PROCESSING METHOD

(71) Applicant: SEIKO EPSON CORPORATION, Tokyo (JP)

(72) Inventor: Norihiko YAMADA, Nagano-shi (JP)

(21) Appl. No.: 15/883,555

(22) Filed: Jan. 30, 2018

(30) Foreign Application Priority Data
Feb. 24, 2017 (JP) 2017-034003

(51) Int. Cl. G06F 3/12; G06F 3/0486; G06F 17/30

(52) U.S. Cl. CPC G06F 3/1268; G06F 17/3089; G06F 3/0486; G06F 3/1203

(57) ABSTRACT

A server of the invention includes: a provision unit configured to provide a web page including at least one drop area; a process object receiving unit configured to receive a process object uploaded via the web page, where uploading of the process object is triggered by dragging-and-dropping the process object onto the at least one drop area; and a transmission processing unit configured to transmit the process object, which has been received, to a printer.

### BACKGROUND

### 1. Technical Field

The present invention relates to a server, a program, and a transmission processing method for transmitting output data to an output apparatus in accordance with a request from a client.

### 2. Related Art

Such a technique is known from JP-A-2012-159915. JP-A-2012-159915 discloses a print control server configured to transmit an electronic message to an electronic-mail address associated with a printer in accordance with a request from a guest terminal.

In JP-A-2012-159915, the print control server provides the guest terminal with a web page for specifying a print object and for performing a print setting operation. However, the web page is configured such that a user gives a print instruction by selecting a print object from a drop-down list. Therefore, the user has to locate the print object from a large number of candidates, which is time-consuming.

### SUMMARY

An advantage of some aspects of the invention is to provide a server, a program, and a transmission processing method for receiving a process object and transmitting the process object to an output apparatus by a simple operation.

A server according to an aspect of the invention includes: a provision unit configured to provide a web page including a drop area; a process object receiving unit configured to receive a process object uploaded via the web page, where uploading of the process object is triggered by dragging-and-dropping the process object onto the drop area; and a transmission processing unit configured to transmit the process object, which has been received, to an output apparatus.

A program according to a further aspect of the invention causes a server to function as a provision unit configured to provide a web page including a drop area; a process object receiving unit configured to receive a process object uploaded via the web page, where uploading of the process object is triggered by dragging-and-dropping the process object onto the drop area; and a transmission processing unit configured to transmit the process object, which has been received, to an output apparatus.

A transmission processing method according to a still further aspect of the invention includes: providing a web page including a drop area; receiving a process object uploaded via the web page, where uploading of the process object is triggered by dragging-and-dropping the process object onto the drop area; and transmitting the process object, which has been received, to an output apparatus, wherein the providing of the web page, the receiving of the process object, and the transmitting of the process object are performed by a server.

With the configuration according to the aspects of the invention, a user can use an output service by a simple operation of dragging and dropping the process object onto the drop area included in the web page. Moreover, the use of the web page as a user interface requires only installation of a web browser in a terminal to which an operation is to be given and does not depend on an environment such as an Operating System (OS).

Note that the output apparatus refers to an apparatus such as a printing apparatus, a display apparatus (including a projector apparatus), a communication apparatus, or an acoustic apparatus configured to output any information to the outside.

In the server, an output setting of the output apparatus is preferably associated with the drop area, and the transmission processing unit preferably converts the process object dropped onto the drop area in accordance with the output setting associated with the drop area and then outputs the process object to the output apparatus.

With this configuration, since the drop area is associated with the output setting, a user can omit a process of specifying the output setting.

In the server, the web page preferably includes a plurality of the drop areas each having different output settings associated therewith, and in each of the drop areas, information denoting the output setting associated with the corresponding one of the drop areas is displayed.

With this configuration, a user refers to the information denoting the output setting displayed in each drop area to specify a desired output setting from a plurality of output setting options.

In the server, the web page preferably includes: an output destination specifying area for specifying an output apparatus which will serve as an output destination; and the drop area, and the transmission processing unit preferably transmits the process object dropped onto the drop area to the output destination specified in the output destination specifying area.

With this configuration, since the web page includes the output destination specifying area, a user can easily specify the output destination (transmission destination of the process object).

In the server, the output apparatus, which is specified as the output destination among one or more output apparatuses associated with a logged-in user, is preferably associated with the web page, and the transmission processing unit preferably transmits the process object to an output destination corresponding to the web page including the drop area onto which the process object is dropped.

With this configuration, a user can specify the output destination from output apparatuses registered in advance. Moreover, in the web page, a print instruction operation (drag-and-drop operation) is given with the output apparatus being identified, and therefore, it is possible to reduce erroneous operations (specifying an output apparatus which is not intended to be the output destination).

In the server, the process object receiving unit preferably notifies the web page of an upload destination when the process object is dropped onto the drop area, and the process object receiving unit preferably receives the process object uploaded to the upload destination via the web page.

With this configuration, it is required only that the upload destination is secured when the process object is dropped onto the drop area, and therefore, it is not needed to prepare the upload destination in advance.

In the server, a program for detecting the drag-and-drop operation is preferably incorporated into the web page, the program preferably performs a registration request of the process object when the program detects that the process object is dropped onto the drop area, and the process object receiving unit preferably performs a notification of the upload destination in response to the registration request of the process object.

With this configuration, since the program incorporated into the web page detects the drag-and-drop operation and performs the registration request of the process object to the server, a separate program is not required.

Note that the server of the invention may be physically realized by one apparatus or by cooperation of a plurality of apparatuses. Moreover, the function of each of components in the description of the invention is not limited to that realized by each of hardware resources physically independent from each other, but a plurality of functions may be realized by one hardware resource, or one function may be realized by a plurality of hardware resources.

### BRIEF DESCRIPTION OF THE DRAWINGS

The invention will be described with reference to the accompanying drawings, wherein like numbers reference like elements.

FIG. 1 is a diagram illustrating a system configuration of a printing system according to an embodiment of the invention.

FIG. 2 is a block diagram illustrating a hardware configuration of a PC.

FIG. 3 is a block diagram illustrating a hardware configuration of a print server.

FIG. 4 is a block diagram illustrating a hardware configuration of a printer.

FIG. 5 is a block diagram illustrating functional components of the print server.

FIG. 6 is a view illustrating a display example (a printer list screen) of a web page.

FIG. 7 is a view illustrating a display example (a print log screen) of the web page.

FIG. 8 is a view illustrating a display example (an upload dialog screen) of the web page.

FIG. 9 is a view illustrating a display example (a print setting dialog screen) of the web page.

FIG. 10 is a sequence diagram illustrating a flow of a printing process.

FIG. 11 is a view illustrating a display example (a drop print screen) of a web page according to a second embodiment.

FIG. 12 is a view illustrating a display example (a print setting creation dialog screen) of the web page according to the second embodiment.

FIG. 13 is a view illustrating a display example (a printer list screen) of a web page according to a third embodiment.

FIG. 14 is a view illustrating a display example (a drag-and-drop print screen) of the web page according to the third embodiment.

FIG. 15 is a view illustrating a display example (a print log screen) of a web page according to a first variation.

FIG. 16 is a view illustrating a display example (a print setting dialog screen) of the web page according to the first variation.

### DESCRIPTION OF EXEMPLARY EMBODIMENTS

### First Embodiment

With reference to the attached drawings, an embodiment of a server, a program, and a transmission processing method of the invention will be described below. In the present embodiment, a print server 2 is illustrated as an example of the server, and a web application 62 is illustrated as an example of a program for operating the server. Moreover, a printer 3 is illustrated as an example of an output apparatus.

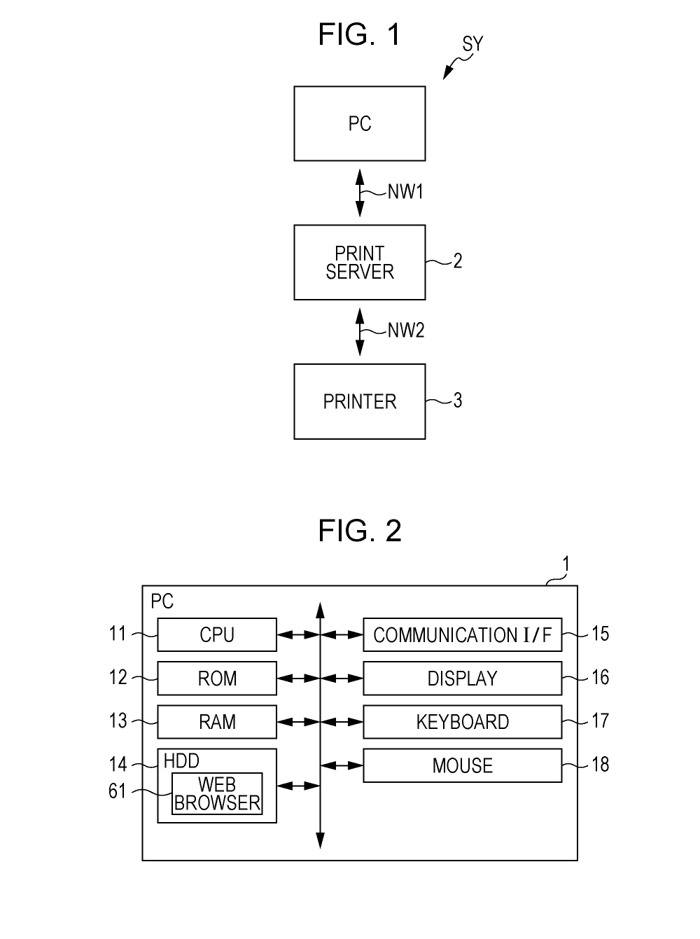

FIG. 1 is a diagram illustrating a system configuration of a printing system SY according to the embodiment of the invention. The printing system SY includes a PC 1, the print server 2, and the printer 3. The print server 2 receives a print object, such as a file, from the PC 1 and converts the print object into print data in a format which can be printed by the printer 3, and the print server 2 transmits the print data to the printer 3. Thus, the printing system SY provides a remote print service (hereinafter denoted as “print service”) which enables a print instruction to be given to the printer 3 located at a remote site. Note that the print object is an example of a process object, and the print data is an example of a converted process object.

As illustrated in FIG. 1, the PC 1 and the print server 2 are connected to each other via a first network NW1, and the print server 2 and the printer 3 are connected to each other via a second network NW2. These networks NW1 and NW2 may be a common network or different networks. Moreover, each of the networks NW1 and NW2 may be realized by a combination of a plurality of networks (for example, wireless LAN and an Internet-based communication network). For convenience, in the following description, the networks NW1 and NW2 are defined as a common network (an Internet-based communication network).

In FIG. 1, one PC 1 and one printer 3 which communicate with the print server 2 are shown, but a plurality of PCs 1 and a plurality of printers 3 may be provided.

The PC 1 realizes various types of functions performed via a web page (a user page) provided by the print server 2. The web page is used for, for example, registering a printer, giving a print object print instruction, checking the status of a printer, and checking the job history of a printer.

Of these functions (hereinafter denoted as “web page functions”) realized by the web page, “registering a printer” refers to associating information (printer name, email address, serial number, and the like) of the printer 3 with a user account in the print service. Registering a printer enables the printer 3 to establish a continuous connection based on a predetermined real-time communication protocol (for example, Extensible Messaging and Presence Protocol (XMPP)) with the print server 2 and to perform real-time communication.

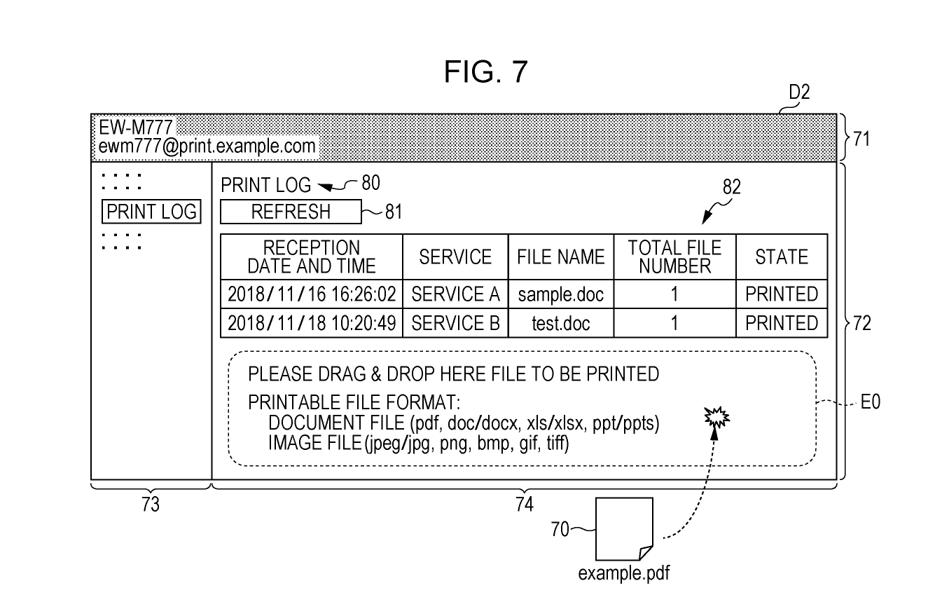

Moreover, the web page function of giving a print object print instruction refers to an operation of dragging and dropping an icon 70 (see, for example, FIG. 7) showing a print object onto a drop area E of the web page. Details will be described later. Moreover, the web page function of checking the status of a printer refers to checking the status of each printer 3 on a corresponding status screen (not shown). Furthermore, the web page function of checking the job history of a printer refers to checking the state (non-printed, printing, printed, etc.) of a job on a corresponding print log screen for each printer 3 (see the status field of log list 82 shown in FIG. 7). Note that in addition to these functions, the web page realizes functions of cancelling a non-printed job, setting print authority on the printer 3, and the like.

The printer 3 is registered in the print service via the web page function of registering a printer and is connected to the print server 2 by a print service connection function being enabled.

Next, with reference to FIGS. 2 to 4, the hardware configurations of the PC 1, the print server 2, and the printer 3 will be described. FIG. 2 is a block diagram illustrating the hardware configuration of the PC 1. The PC 1 includes a central processing unit (CPU) 11, read only memory (ROM) 12, random access memory (RAM) 13, a hard disk drive (HDD) 14, a communication interface (hereinafter denoted as “communication I/F”) 15, a display 16, a keyboard 17, and a mouse 18.

The CPU 11 inputs and outputs signals to and from each of the components in the PC 1 to perform various types of arithmetic processing. The ROM 12 is a non-volatile memory medium and stores various types of control programs and various types of control data. The RAM 13 is a volatile memory medium and is used as a work area of the CPU 11. The HDD 14 is an auxiliary memory apparatus and stores a web browser 61 and the like for displaying the web page.

The communication I/F 15 communicates with the print server 2 via an Internet-based communication network (the first network NW1). The communication is performed mainly to communicate with the web page and to upload the print object. The display 16 displays various types of information such as the web page displayed by the web browser 61. The keyboard 17 and the mouse 18 are used by a user to input information.

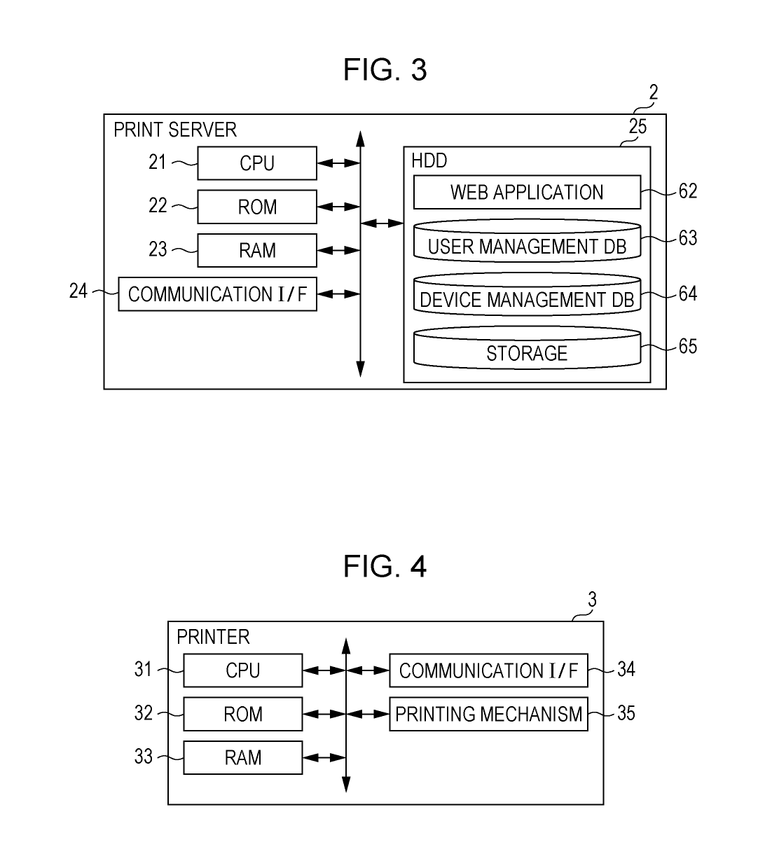

FIG. 3 is a block diagram illustrating the hardware configuration of the print server 2. The print server 2 includes a CPU 21, ROM 22, RAM 23, communication I/F 24, and HDD 25.

The CPU 21 inputs and outputs signals to and from each of the components in the print server 2 to perform various types of arithmetic processing. The ROM 22 stores various types of control programs and various types of control data. The RAM 23 is used as a work area of the CPU 21. The communication I/F 24 communicates with the PC 1 and the print server 3 via Internet-based communication networks (the networks NW1 and NW2). Note that when the networks NW1 and NW2 are different networks, the print server 2 includes individual interfaces corresponding to communication protocols of the networks NW1 and NW2.

The HDD 25 stores the web application 62. The print server 2 uses the function of this web application 62 to realize, for example, provision of the web page and a transmission process of the print data. The HDD 25 further includes a user management database (hereinafter denoted as “user management DB”) 63, a device management database (hereinafter denoted as “device management DB”) 64, and storage 65.

The user management DB 63 stores a user account (a user ID and a password) including personal information for each user. The device management DB 64 stores information (the printer name, email address, serial number, print setting, and the like) of the printer 3. The storage 65 stores the print object uploaded via the web page (the PC 1 which displays the web page), information denoting the print setting of the print object, and the like.

Note that in FIG. 3, the print server 2 is shown as one server, but the print server 2 may be realized by a plurality of servers. In this case, the program of the invention is realized by a collection of web applications incorporated into the servers.

FIG. 4 is a block diagram illustrating the hardware configuration of the printer 3. The print server 3 includes a CPU 31, ROM 32, RAM 33, communication I/F 34, and printing mechanism 35.

The CPU 31 inputs and outputs signals to and from each of the components in the printer 3 to perform various types of arithmetic processing. The ROM 32 stores firmware and the like of the printer 3. The RAM 33 is used as a work area of the CPU 31.

The communication I/F 34 communicates with the print server 2 via an Internet-based communication network (the second network NW2). The printing mechanism 35 performs printing in accordance with the print data transmitted from the print server 2. The print data transmitted from the print server 2 includes image data (a bitmapped image) in the Portable Network Graphics (PNG) format and a control command based on the ESC/P-R protocol. Note that the printing mechanism 35 includes a plurality of paper feeder (paper cassettes), and it is assumed that different types of paper are loaded. Moreover, the printing mechanism 35 enables color/monochrome printing, double-sided/single-sided printing, and layout printing. The term “layout printing” denotes a function of printing a plurality of pages laid out on one sheet of print paper.

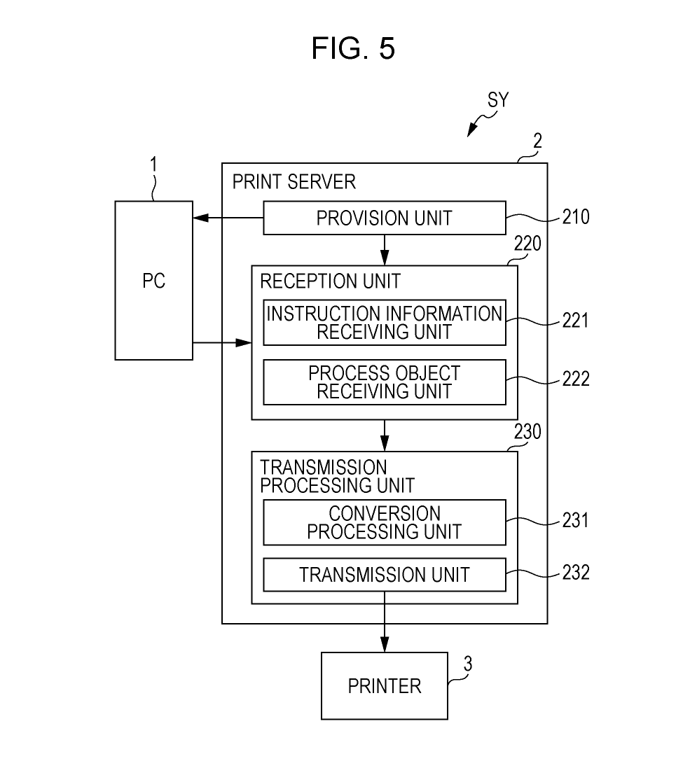

Next, with reference to FIG. 5, the functional components of the print server 2 will be described. The print server 2 includes a provision unit 210, a reception unit 220, and a transmission processing unit 230 as functional components. These functional components correspond to functions all realized by the web application 62 operated by the CPU 21.

The provision unit 210 provides the PC 1 with the web page including the drop area E (provision step). The PC 1 displays the web page, which has been provided, on the display 16 by using the web browser 61. A user uses the web page, which has been displayed, as a user interface to perform various types of operations such as giving a print instruction.

The reception unit 220 includes an instruction information receiving unit 221 and a process object receiving unit 222. The instruction information receiving unit 221 receives instruction information generated in accordance with an operation result of the web page. In the present embodiment, the instruction information receiving unit 221 receives, as the instruction information, information denoting the print setting of the printer 3 (hereinafter denoted as “print setting information”) and a job registration request which requests the print server 2 to register (upload) the print object. Note that the print setting is an example of an output setting, and the job registration request is an example of a registration request of a process object.

The process object receiving unit 222 receives the print object uploaded via the web page (process object reception step). The web page uploads the print object, where uploading of the print object is triggered by dragging-and-dropping the icon 70 of the print object onto the drop area E. That is, when the web page detects that the icon 70 is dropped onto the drop area E, the web page uploads the print object (a file) corresponding to the icon 70 to the print server 2 without requiring a print execution operation to be performed.

The transmission processing unit 230 includes a conversion processing unit 231 and a transmission unit 232. The conversion processing unit 231 converts the print object received via the web page into print data (image data and a control command). The print setting information is reflected in the image data and the control command included in the print data. In the present embodiment, the image data and the control command of the print setting information are generated as the print data. A color/monochrome setting is reflected in the image data. A paper setting (including a paper type setting and a paper size setting), a single-sided/double-sided setting, and a layout setting are reflected in the control command. The print data generated by the conversion processing unit 231 is registered as a job in a predetermined storage area (a job queue of a specified printer 3) in the storage 65.

The transmission unit 232 transmits the print data which is generated by the conversion processing unit 231 (and which is obtained by converting the print object) to the specified printer 3 (transmission process step). Note that a user specifies a transmission destination of the print data among one or more printers 3 associated with the logged-in user. After the print data is generated by the conversion processing unit 231 and is registered as a job, the transmission unit 232 receives a print start instruction via the web page and then performs a job notification to cause the specified printer 3 to acquire the print data and to execute printing. The job notification is a push notification in XMPP message format to notify the printer 3 of the presence of print data to be printed and an address (URL) denoting where in the print server 2 the data is stored. When the printer 3 accesses the notified URL via Hypertext Transfer Protocol Secure (HTTPS), the transmission unit 232 transmits the print data via HTTPS to the printer 3.

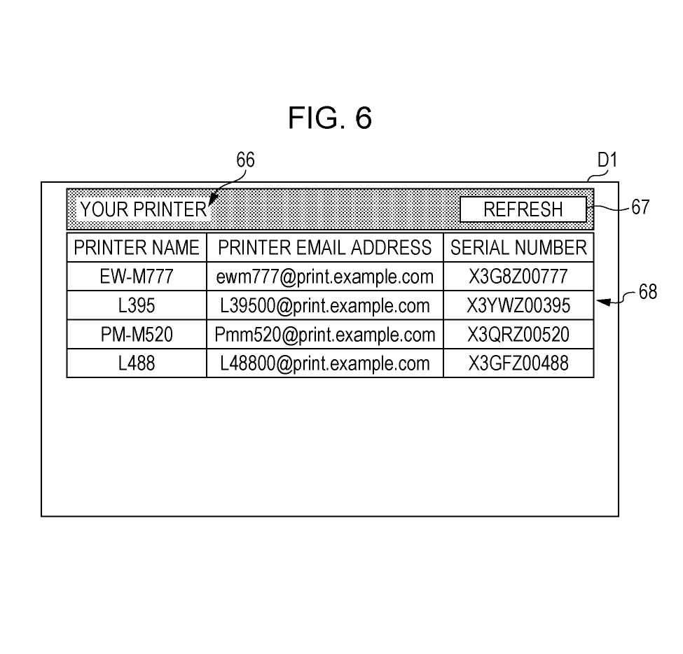

Next, with reference to FIGS. 6 to 9, the operation of the web page (the print instruction operation) will be described. The screens shown in FIGS. 6 to 9 are all provided as web pages by the print server 2 and are displayed by the web browser 61 of the PC 1. A screen D1 shown in FIG. 6 is a printer list screen. This printer list screen is displayed when a user logs in via a login screen (web page) which is not shown.

As illustrated in FIG. 6, the printer list screen displays a screen title 66, a refresh button 67, and a printer list 68. When the refresh button 67 is selected, information which is newest is reflected in the printer list 68. The printer list 68 displays information of the printers 3 registered in association with the user account of the logged-in user. The printer list 68 is in table format, where the information of each printer 3 is assigned to an associated row, and the list contains a printer name field, a printer email address field, and a serial number field as rows.

When any one printer 3 from the printer list 68 is specified, a printer screen corresponding to the specified printer 3 is displayed. The print log screen shown in a screen D2 of FIG. 7 is an example of the printer screen. Note that when only one printer 3 is registered in association with a logged-in user, displaying the printer list screen is omitted, and the login screen transitions directly to the printer screen. The printer screen can be switched to various types of screens by specifying an item in an item selection area 73 of the printer screen, but a default screen to which the printer list screen transitions is a printer status screen (not shown). The printer status screen displays various statuses of the specified printer 3 (a state of connection to the print server 2, enabling/disabling of a remote print function, the number of non-printed jobs, a paper setting, and the like).

When “print log” is selected in the item selection area 73 of the printer status screen, the print log screen shown in the screen D2 of FIG. 7 is displayed. The printer screen including the print log screen includes an upper area 71 and a lower area 72. In the upper area 71, the name of the printer 3 and the email address registered in association with the printer 3 are displayed.

Moreover, the lower area 72 of the printer screen includes the item selection area 73 and a main area 74. The main area 74 of the print log screen is a print log area. In the item selection area 73, items for displaying the printer status screen, the print log screen, and the like of the specified printer 3 are displayed.

The main area 74 (the print log area) displays a screen title 80, a refresh button 81, the log list 82, and a drop area E0. When the refresh button 81 is selected, information which is newest is reflected in the log list 82. The log list 82 displays the print history of the specified printer 3 in rows. The log list 82 contains a reception date and time field, a service field, a file name field, a total file number field, and a state field as rows. The reception date and time field displays the date and time at which the print data was received by the print server 2. Moreover, the service field displays the type of service in which a print job is registered to the printer 3. Examples of the service include a print service for causing the printer 3 to perform printing via the print server 2 from a print application installed on a smartphone and a print service for causing the printer 3 to perform printing via the print server 2 from an application such as a printer driver installed on the PC 1, and additionally, a service for causing the printer 3 to perform printing by uploading a print object via the web page to the print server 2. In the example shown in FIG. 7, printing of the file “sample.doc” shown in the first row in the log list 82 is based on a service A, and printing of the file “test.doc” shown in the second row is based on a service B. Moreover, in the field of a state, the state (“non-printed”, “printing”, “printed” or the like) of a job is displayed.

The drop area E0 displays a message for prompting a drag-and-drop operation and displays a printable file format in text. The printable file format is displayed by being classified as a document file or an image file.

Here, when a user drops the icon 70 visible on the user interface (for example, a file manager, a desktop area, etc.) of the PC 1 onto the drop area E0 by the drag-and-drop operation, an event handler set to the drop area E0 performs a job registration request to the print server 2. Note that the event handler is an example of a program for detecting the drag-and-drop operation. When receiving the job registration request, the print server 2 creates print job information for the printer 3. Then, the print server 2 notifies the event handler of the upload destination of the print object associated with the print job information. The event handler uploads the print object to the notified upload destination.

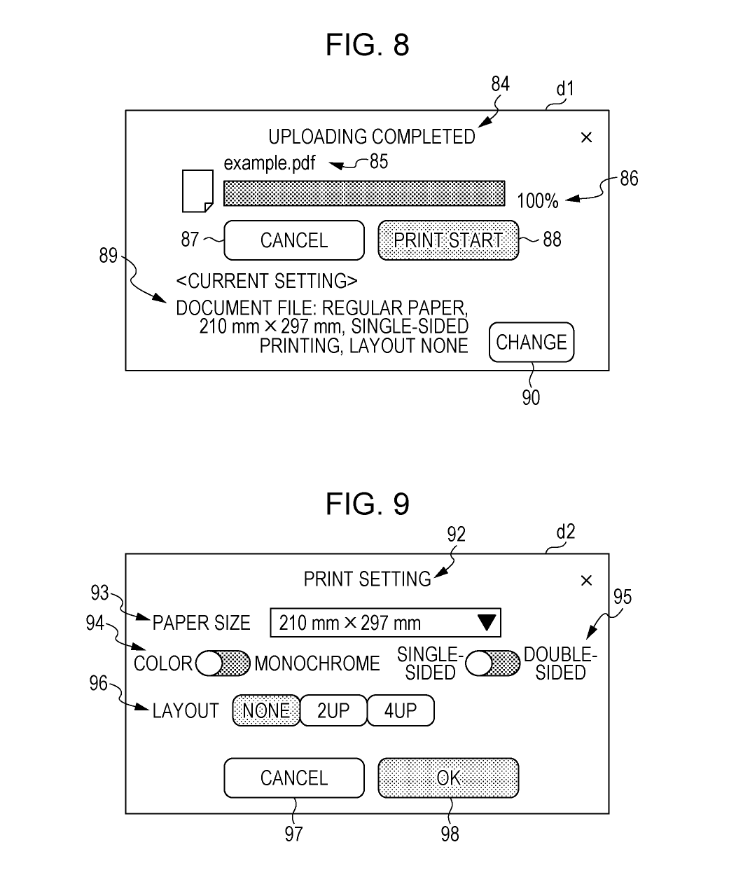

Moreover, when the event handler starts uploading the print object, the web browser 61 displays an upload dialog screen shown in a screen d1 of FIG. 8. The upload dialog screen displays a message 84 showing a completion of uploading of the print object, a file name 85 of the print object, a progress bar 86 showing uploading progress, a cancel button 87, a print start button 88, a print setting 89, and a change button 90.

When the cancel button 87 is selected, the upload dialog screen is hidden. Alternatively, when the print start button 88 is selected, the print server 2 performs the job notification to the printer 3. The print setting 89 shows set values set in the specified printer 3. The set values may be default values prescribed for each of the printers 3 or may be the most recently set values for each of the printers 3. The example in FIG. 8 shows an upload dialog screen in the case where a file in a file format (PDF format, see the icon 70 in FIG. 7) corresponding to a document file is dropped. Thus, as the print setting 89, set values of the document file are displayed. When the print start button 88 is selected in the state shown in FIG. 8, print setting information denoting the print setting 89 is reflected in the print data.

However, when the change button 90 is selected, a print setting dialog screen shown in a screen d2 in FIG. 9 is displayed. The print setting dialog screen displays a screen title 92, a paper size selection drop-down list 93, a color/monochrome selection button 94, a single-sided/double-sided selection button 95, a layout selection button 96, a cancel button 97, and an “OK” button 98.

When the “cancel” button 97 is selected, the print setting dialog screen is hidden, and the upload dialog screen shown in the screen d1 in FIG. 8 is displayed. Alternatively, when the “OK” button 98 is selected, the web page (web browser 61) re-displays the print setting information in accordance with the setting in the print setting dialog screen and reflects the set values in the print setting 89 of the upload dialog screen.

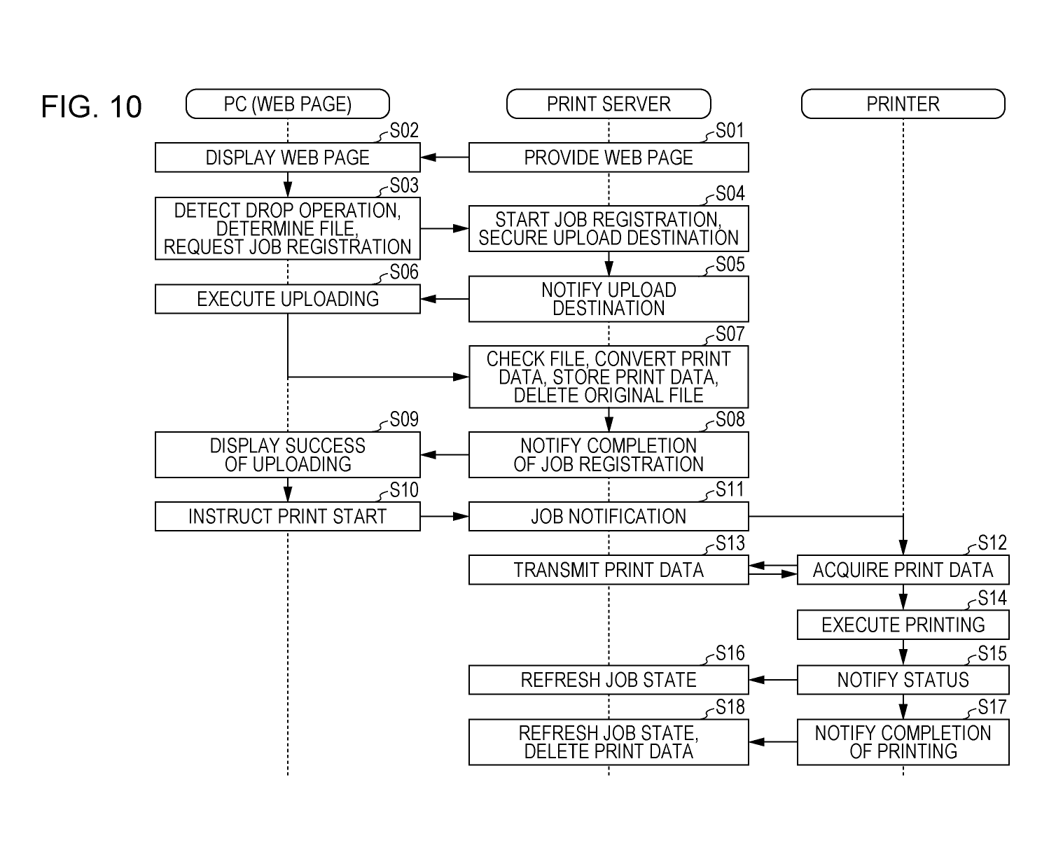

Next, with reference to the sequence diagram in FIG. 10, a flow (including a transmission processing method of the print server 2) of the printing process by the PC 1 (web page), a print server 2, and the printer 3 will be described. First, the print server 2 provides the PC 1 with a web page (S01). The PC 1 displays the provided web page provided by the web browser 61 (S02). Thereafter, when the PC 1 (web page) detects that the icon 70 is dropped onto the drop area E of the web page by a drag-and-drop operation, the PC 1 determines whether or not the dropped file is a file printable by the print service. When determining that the file is printable, the PC 1 transmits a job registration request to the print server 2 (S03). The PC 1 (web page) also transmits print setting information denoting a print setting of the specified printer 3 (printer 3 associated with the web page serving as an operation target) together with the job registration request. Note that S03 is a step executed in accordance with the event handler set to the drop area E.

When receiving the job registration request from the PC 1 (web page), the print server 2 starts job registration, secures an upload destination of the file (S04), and notifies the PC 1 (web page) of the upload destination (S05). The PC 1 (web page) uploads a file corresponding to the icon 70 dropped onto the drop area E to the notified upload destination (S06).

The print server 2 checks the uploaded file for a virus and determines whether or not the uploaded file is in a printable format. When no problem is found, the print server 2 converts the uploaded file into print data. Moreover, the print server 2 stores the print data after the conversion in a job queue for the specified printer 3 and deletes the original file which is the conversion source of the print data (S07). Thereafter, the print server 2 notifies the PC 1 (web page) of a status code indicating that the job is normally registered as a job registration completion notification (S08).

The PC 1 (web page) receives the notification of S08 and displays that the uploading has been successfully performed (S09). This display corresponds to the message denoted by reference symbol 84 in the upload dialog screen (see FIG. 8). Note that when the uploading fails, the PC 1 (web page) displays an error at this time point. Thereafter, the PC 1 (web page) transmits the print start instruction to the print server 2 (S10), which triggers the printer server 2 to perform the job notification to the specified printer 3 (S11).

Note that when the print setting is changed in the print setting dialog screen (see FIG. 9), the PC 1 (web page) transmits print setting information denoting the print setting after the change to the print server 2 in S10, and the print server 2 reconverts the print data in accordance with the print setting information. Alternatively, without deleting the original file in S07, the print server 2 may perform conversion from the original file after the print setting information is transmitted in S10. Alternatively, the PC 1 (web page) does not have to transmit the print setting information in S03 but may transmit the print setting information together with the print start instruction in S10, and the print server 2 may convert the print data before the job notification in S11.

When the printer 3 receives the job notification from the print server 2, the printer 3 is triggered by the reception of the job notification to access a storage address (job queue) of the print data via HTTPS so as to acquire the print data from the print server 2 (S12). Alternatively, the printer 3 may request the print server 2 to transmit the print data. In this way, the print server 2 transmits the print data to the printer 3 (provides the printer 3 with the print data) in any way (S13). When acquiring the print data, the printer 3 performs required processes therein and then performs printing (S14). The printer 3 notifies the print server 2 of the status of processes in accordance with stages of the processes (S15), and the print server 2 refreshes the state of the job in accordance with the notification (S16). Moreover, when completing the printing, the printer 3 notifies the print server 2 of the status of print completion (S17), and the print server 2 refreshes the state of the job and deletes the print data from the storage address (S18).

As described above, the printing system SY of the present embodiment enables a user to give a print instruction to the print server 2 by a simple operation of dragging and dropping the icon 70 of a print object onto the drop area E set in the web page. Moreover, the web page is used as a user interface, and therefore, the PC 1 for performing the operation requires only that the web browser 61 is installed, and the printing system SY does not depend on the environment such as the OS.

Moreover, the printer 3 which is to be the output destination is associated with the web page (the print log screen, see FIG. 7) including the drop area E, and therefore, a user can omit a step of specifying the output destination. Furthermore, the printer 3 is identified in the print log screen, and therefore, it is possible to reduce erroneous operation (specifying a printer 3 which is not intended to be the output destination) by a user.

Moreover, since the upload dialog screen (see FIG. 8) displayed after the uploading of the print object enables the print setting dialog screen (see FIG. 9) to be displayed, a user can give an instruction of a desired print setting. Furthermore, as illustrated in FIG. 10, when a print start instruction operation is performed by using the web page, the printer 3 immediately performs printing, and therefore, it is possible to rapidly obtain a printed material.

### Second Embodiment

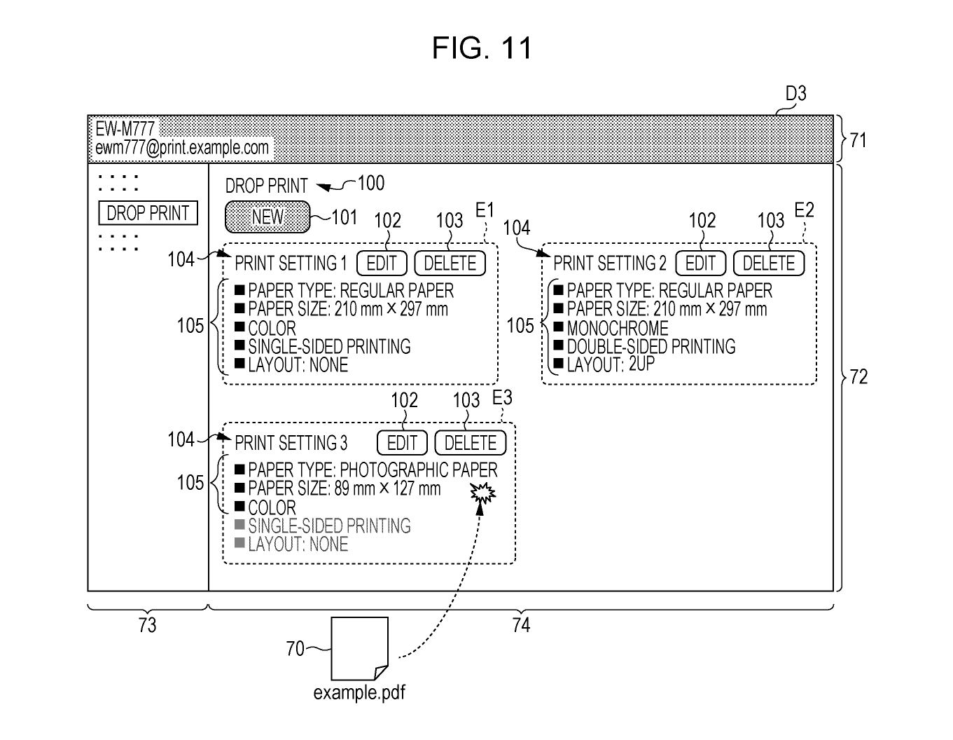

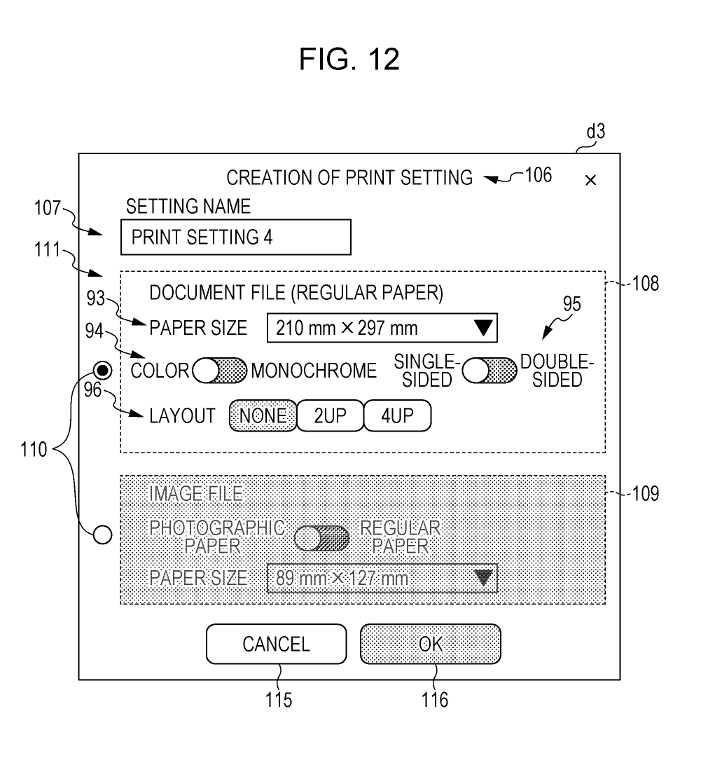

Next, with reference to FIGS. 11 and 12, a second embodiment of the invention will be described. In the present embodiment, specifying the print object and giving an instruction of a print setting are simultaneously performed. Only differences from the first embodiment will be described below. Note that in the present embodiment, components similar to those in the first embodiment are denoted by the same reference symbols as those in the first embodiment, and the detailed description thereof will be omitted. Moreover, variations applied to components similar to those in the first embodiment are similarly applied to the present embodiment.

A printer 3 of the present embodiment includes two paper feeders, and in one of the two paper feeders, 210 mm×297 mm regular paper sheets are loaded, and in the other of the two paper feeders, 89 mm×127 mm photographic paper sheets are loaded. Moreover, a transmission processing unit 230 of the present embodiment converts a print object in accordance with a print setting associated with a drop area E (conversion processing unit 231) to obtain print data after the conversion and transmits the print data to the printer 3 (transmission unit 232).

A screen D3 shown in FIG. 11 is a drop print screen. The drop print screen is an example of a printer screen corresponding to each of printers 3, and a main area 74 is a drop print area. The main area 74 (the drop print area) displays a screen title 100, a new button 101, and a drop area E. Note that the drop area E is displayed when the print setting has been already created by a print setting creation dialog screen (see FIG. 12) which will be described later. In FIG. 11, three drop areas E1 to E3 are created.

When the new button 101 is selected, a print setting creation dialog screen shown in a screen d3 in FIG. 12 is displayed. The screen d3 shows a state in which the print setting has been performed, but when the new button 101 is selected, the screen d3 shows a print setting creation dialog screen in an unset state.

Each of the drop areas E1 to E3 displays an “edit” button 102 and a “delete” button 103, and additionally, a setting name 104 and print setting values 105 in text. When the “edit” button 102 is selected, a print setting creation dialog screen in which an existing print setting (the print setting values 105 displayed in the corresponding drop area E) is reflected is displayed. Alternatively, when the “delete” button 103 is selected, the corresponding drop area E is hidden.

In the state shown in FIG. 11, a user drags and drops the icon 70 of the print object onto the drop area E3, which enables specification of the print object (a print object print instruction) and an instruction of the print settings (“paper type: photographic paper”, “paper size: 89 mm×127 mm”, “color/monochrome setting: color”) shown by the print setting values 105 in the drop area E3. Note that a web page detects, by an event handler set to each drop area E, a Document Object Model (DOM) factor or a coordinate of a site where the icon 70 is dropped by a drag-and-drop operation, and based on a result of the detection, the web page identifies the print setting. Then, the web page transmits print setting information denoting the identified print setting together with a job registration request to a print server 2.

Note that as in the drop area E3, when “photographic paper” is selected as the paper type, the printer 3 can perform neither double-sided printing nor layout printing, and therefore, the print setting values 105 for a single-sided/double-sided setting and a layout setting are grayed out.

The screen d3 in FIG. 12 is the print setting creation dialog screen. The print setting creation dialog screen displays a setting name input box 107, a document file setting field 108, an image file setting field 109, radio buttons 110, a “cancel” button 115, and an “OK” button 116.

A user uses the radio buttons 110 to select for which one of a document file and an image file a print setting is performed. In the example shown in FIG. 12, the document file is selected, and therefore, the image file setting field 109 is in a state where settings are disabled. The document file setting field 108 displays a file type 111, a paper size selection drop-down list 93, a color/monochrome selection button 94, a single-sided/double-sided selection button 95, and a layout selection button 96.

When the “cancel” button 115 is selected, a setting in the print setting creation dialog screen is canceled, and the print setting creation dialog screen is hidden. In contrast, when the “OK” button 116 is selected, the setting in the print setting creation dialog screen is reflected in the drop print screen (see FIG. 11). That is, a fourth drop area E is added to the main area 74 (the drop print area), and as the setting name 104, “print setting 4” is displayed, and as the print setting values 105, “paper type: regular paper”, “paper size: 210 mm×297 mm”, “color/monochrome setting: color”, “single-sided/double-sided setting: double-sided”, “layout setting: none” are displayed.

As described above, in the print system SY of the present embodiment, the print setting is associated with the drop area E, and therefore, a user can omit a process of specifying the print setting. Moreover, the plurality of drop areas E corresponding to different print settings are displayed, and therefore, a user can rapidly specify a desired output setting.

Moreover, the present embodiment requires no print setting after uploading the print object, and a print start instruction operation (see S10 in FIG. 10) is not required, which enables the print server 2 to perform a job notification to the printer 3 in accordance with the completion of uploading of the print object. That is, S10 in FIG. 10 is omitted, and the process may proceed from S07 directly to S11. Thus, it is possible to cause the printer 3 to perform printing immediately after the web page detects a drag-and-drop operation.

### Third Embodiment

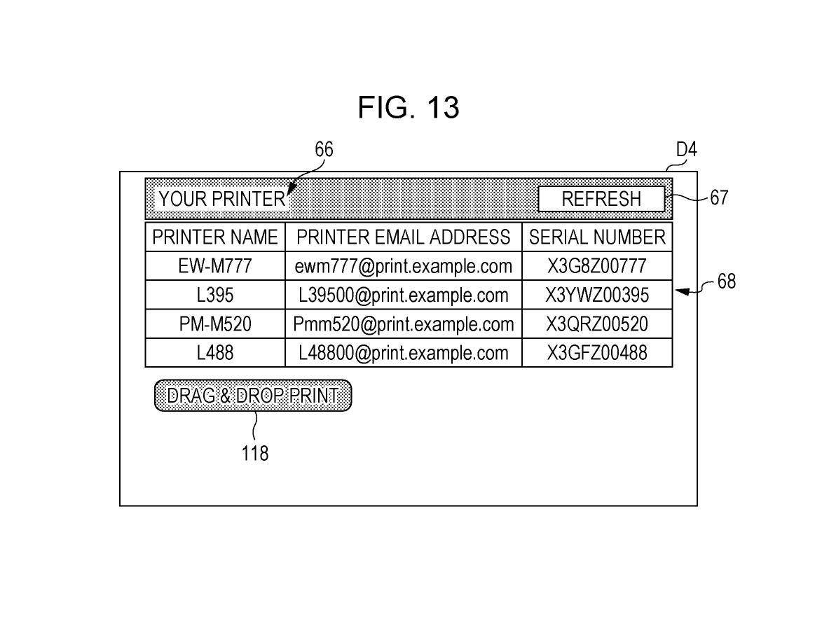

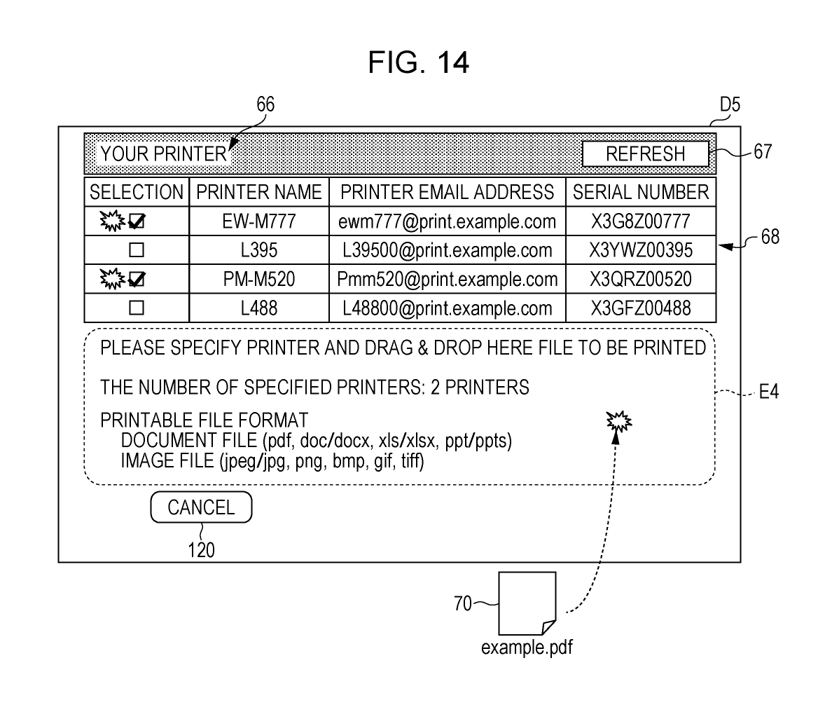

Next, with reference to FIGS. 13 and 14, a third embodiment of the invention will be described. In the present embodiment, a printer list screen is used to specify an output destination. Only differences from the first embodiment will be described below. Note that in the present embodiment, components similar to those in the first embodiment are denoted by the same reference symbols as those in the first embodiment, and the detailed description thereof will be omitted. Moreover, variations applied to components similar to those in the first embodiment are similarly applied to the present embodiment.

A screen D4 shown in FIG. 13 is the printer list screen according to the third embodiment. The printer list screen has a configuration in which a drag-and-drop print button 118 is added to the printer list screen (see FIG. 6) of the first embodiment. When the drag-and-drop print button 118 is selected, a drag-and-drop print screen shown in screen D5 in FIG. 14 is displayed. Note that the drag-and-drop print screen may be a screen different from the printer list screen or may be the same screen as the printer list screen, and for example, when the drag-and-drop print button 118 is pressed, a drop area E4 may be displayed in an area below the drag-and-drop print button 118.

The drag-and-drop print screen displays a screen title 66, a refresh button 67, a printer list 68 and further displays the drop area E4 and a “cancel” button 120. The printer list 68 displayed in the drag-and-drop print screen has a selection field including checkboxes each corresponding to an associated one of printers 3, and a user can specify each output destination by checking an associated one of the checkboxes. Here, the number of the output destinations specified is not limited to one, but a plurality of printers may be specified. Note that the printer list 68 of the drag-and-drop print screen is an example of an output destination specifying area.

Moreover, the drop area E4 displays a message which prompts specifying a printer 3 and performing a drag-and-drop operation, the number of printers specified, and a printable file format in text. The printable file format is displayed by being classified as a document file or an image file.

In the state shown in FIG. 14, when a user drops the icon 70 onto the drop area E4 by a drag-and-drop operation, the web page identifies two printers 3 (printer “EW-M777” and “PM-M520”) as output destinations. Then, the web page transmits output destination information denoting the identified output destinations together with a job registration request to a print server 2. The print server 2 stores print data obtained by converting a file corresponding to the icon 70 in job queues corresponding to the respective two printers 3 and performs job notification to the two printers 3. Note that when the “cancel” button 120 is selected in the drag-and-drop print screen, the setting is canceled, the drag-and-drop print screen is hidden, and the printer list screen in FIG. 13 is displayed.

Note that although not particularly shown in the figure, when the icon 70 is dropped onto the drop area E4, the PC 1 (web page) displays the upload dialog screen (see FIG. 8) for each of the printers 3. Thus, even when the plurality of printers 3 are caused to print the same content, it is possible to perform different print settings for the printers 3.

As described above, in the print system SY of the present embodiment, the drag-and-drop print screen includes a printer list 68 for specifying the output destination, and therefore, a user can easily specify the output destination. Moreover, in the printer list 68, a plurality of output destinations can be specified, which provides convenience when the plurality of printers 3 are to be caused to print the same content.

While three embodiments have been described above, these embodiments are not intended to be limiting, but the following variations can be used.

### First Variation

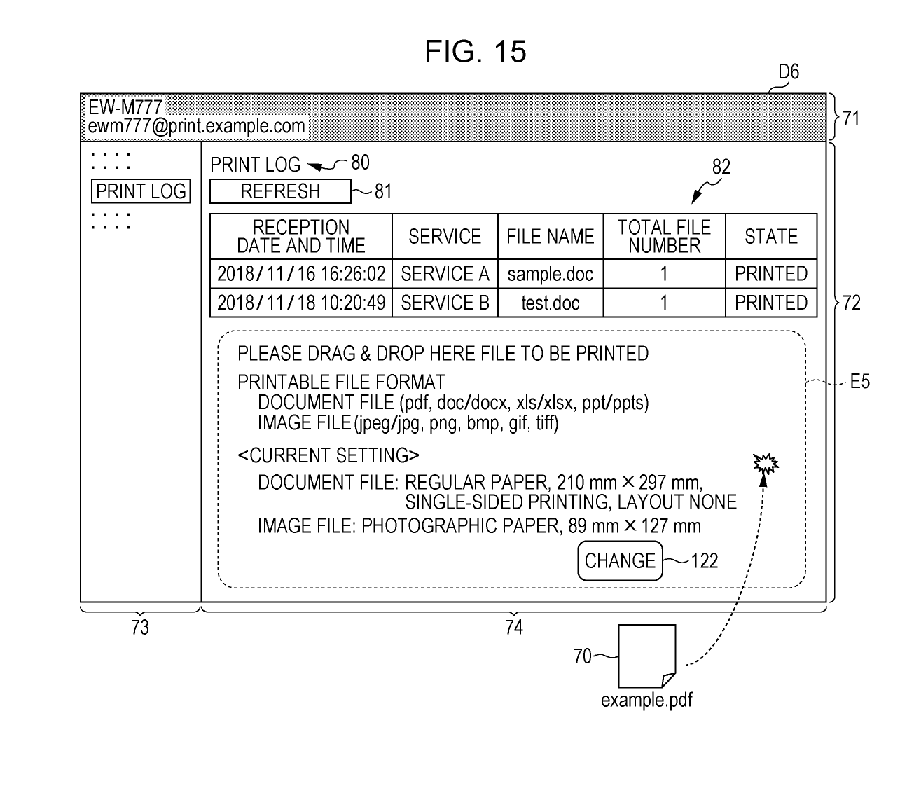

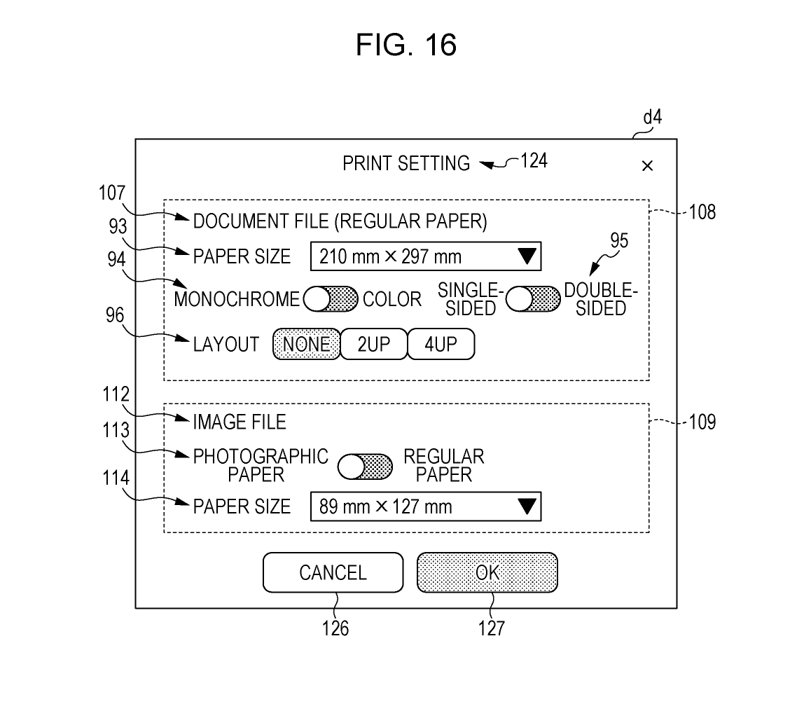

In the first embodiment, the print setting is changed (see the upload dialog screen d1 in FIG. 8) after the print object is uploaded via the web page. However, the print object may be uploaded after the print setting is performed. Now, with reference to FIGS. 15 and 16, a print instruction operation according to a first variation will be described. FIG. 15 shows a print log screen according to the first variation.

The print log screen according to the first variation is different from the print log screen (see FIG. 7) according to the first embodiment in that a print setting is displayed in text in a drop area E5. The print setting is a set value set in the printer 3 to which the print log screen corresponds. The print setting may be a prescribed default value or the most recently set value. Moreover, the print setting is displayed being classified as a document file or an image file. In the state shown in FIG. 15, when the icon 70 is dropped onto the drop area E5, the PC 1 (web page) transmits a file corresponding to the icon 70 and the print setting information denoting the print setting displayed in the drop area E5 to the print server 2. In the example in FIG. 15, the icon 70 is in a file format corresponding to the document file, and therefore, the print setting information denoting the print setting of the document file is transmitted. Note that in the print log screen shown in FIG. 15, when the “change” button 122 is selected, a print setting dialog screen shown in a screen d4 in FIG. 16 is displayed.

The print setting dialog screen displays a screen title 124, a document file setting field 108, an image file setting field 109, a “cancel” button 126, and an “OK” button 127. The display item of the document file setting field 108 is similar to the print setting creation dialog screen (see FIG. 12) according to the second embodiment. Moreover, the image file setting field 109 displays a file type 112, a photographic paper/regular paper selection button 113, and a paper size selection drop-down list 114. When the “cancel” button 126 is selected, the setting is canceled, and the print setting dialog screen is hidden. Alternatively, when the “OK” button 127 is selected, the setting of the print setting dialog screen is reflected in the drop area E5 of the drop print screen.

Note that similarly to the second embodiment, the present variation requires no print setting after uploading of the print object, which enables the print server 2 to perform a job notification to the printer 3 in accordance with the completion of the uploading of the print object. That is, without waiting for a print start instruction via the web page, the process may proceed from S07 of FIG. 10 directly to S11.

### Second Variation

In the third embodiment, the print setting is performed for each of the printers 3 after the print object is uploaded. However, the same print setting may be reflected in all the output destinations specified by the printer list 68. In this case, as in the first variation, specifying of the print object (a drag-and-drop operation of the icon 70) may be performed after the print setting is performed.

### Third Variation

In the third embodiment, the printer list 68 is used to specify the output destination, but the plurality of drop areas E corresponding to different output destinations may be provided on the web page so as to enable identification of the output destination in accordance with a drop area in which the icon 70 is dropped. Moreover, a combination with the second embodiment may be made to provide a plurality of drop areas E which are different from each other in terms of the print setting and the output destination so as to enable identification of the output destination and the print setting in accordance with the drop area in which the icon 70 is dropped.

### Fourth Variation

In the first to third embodiments and the first variation, a case where one file is dragged and dropped is taken as an example (see FIGS. 7, 11, 14, and 15). However, a plurality of files may be selected and dragged and dropped to give a print instruction of the plurality of files. Moreover, the print instruction may be given with a folder, but not with a file, as a print object.

### Fifth Variation

In the first to third embodiments, the print data is generated in accordance with the print setting information included in the instruction information received by the instruction information receiving unit 221, but the reception of the instruction information may be omitted. That is, the print data may be generated in accordance with a prescribed print setting or print setting information acquired regardless of an operation of specifying the print object.

### Sixth Variation

In the first to third embodiments, the PC 1 is illustrated as an example of a terminal for operating the web page, but the web page may be operated by using an information processing terminal such as a tablet terminal other than the PC 1.

### Seventh Variation

In the first to third embodiments, the printer 3 is illustrated as an example of the output apparatus, but the present embodiment may be applied to other output apparatuses. Examples of other output apparatuses include a display apparatus (including a projector apparatus), a communication apparatus, and an acoustic apparatus. In this case, as the output settings of the display apparatus, the communication apparatus, and the acoustic apparatus, a display setting, a communication setting, and an acoustic setting can respectively be instructed.

### Eighth Variation

Each component (each function) in the apparatuses in the printing system SY shown in each of the embodiment and the variations described above may be provided as a program. Moreover, the program may be provided as various types of recording media (CD-ROM, flash memory, etc.) storing the program. That is, a program for causing the computer to function as each of the components (each of the functions) in a corresponding one of the apparatuses in the printing system SY and a computer-readable recoding medium in which the program is stored are also within a scope of the invention. Other modifications may be made accordingly without deviating from the scope of the invention.

The entire disclosure of Japanese Patent Application No. 2017-34003, filed Feb. 24, 2017 is expressly incorporated by reference herein.

What is claimed is:

1. A server comprising:
a provision unit configured to provide a web page including a drop area;
a process object receiving unit configured to receive a process object uploaded via the web page, where the process object is uploaded by dragging-and-dropping the process object onto the drop area; and
a transmission processing unit configured to transmit the process object, which has been received, to an output apparatus.

2. The server according to claim 1, wherein
an output setting of the output apparatus is associated with the drop area, and
the transmission processing unit converts the process object dropped onto the drop area in accordance with the output setting associated with the drop area and then outputs the process object to the output apparatus.

3. The server according to claim 2, wherein
the web page includes a plurality of the drop areas each having different output settings associated therewith, and
in each of the drop areas, information denoting the output setting associated with the corresponding one of the drop areas is displayed.

4. The server according to claim 1, wherein
the web page includes:
an output destination specifying area for specifying an output apparatus which will serve as an output destination; and
the drop area, and
the transmission processing unit transmits the process object dropped onto the drop area to the output destination specified in the output destination specifying area.

5. The server according to claim 1, wherein
the output apparatus, which is specified as the output destination among one or more output apparatuses associated with a logged-in user, is associated with the web page, and
the transmission processing unit transmits the process object to an output destination corresponding to the web page including the drop area in which the process object is dropped.

6. The server according to claim 1, wherein
the process object receiving unit notifies the web page of an upload destination when the process object is dropped onto the drop area, and the process object receiving unit receives the process object uploaded to the upload destination via the web page.

7. The server according to claim 6, wherein
a program for detecting the drag-and-drop operation is incorporated into the web page,
the program performs a registration request of the process object when the program detects that the process object is dropped onto the drop area, and
the process object receiving unit performs a notification of the upload destination in response to the registration request of the process object.

8. A program which causes a server to function as
a provision unit configured to provide a web page including a drop area;
a process object receiving unit configured to receive a process object uploaded via the web page, where the process object is uploaded by dragging-and-dropping the process object onto the drop area; and
a transmission processing unit configured to transmit the process object, which has been received, to an output apparatus.

9. A transmission processing method comprising:
providing a web page including a drop area;
receiving a process object uploaded via the web page, where the process object is uploaded by dragging-and-dropping the process object onto the drop area; and
transmitting the process object, which has been received, to an output apparatus wherein
the providing of the web page, the receiving of the process object, and the transmitting of the process object are performed by a server.
